(19) United States
(12) Patent Application Publication
(10) Pub. No.: US 2015/0116387 A1
(43) Pub. Date: Apr. 30, 2015

(54) LUMINANCE CORRECTION SYSTEM

(71) Applicant: SAMSUNG DISPLAY CO., LTD., Yongin-City (KR)

(72) Inventors: Byung-Geun JUN, Yongin-City (KR); Min-Cheol KIM, Yongin-City (KR); In-Hwan KIM, Yongin-City (KR); An-Su LEE, Yongin-City (KR); Sang-Kyun CHO, Yongin-City (KR)

(21) Appl. No.: 14/517,966

(22) Filed: Oct. 20, 2014

(30) Foreign Application Priority Data
Oct. 28, 2013 (KR) 10-2013-0128391

(51) Int. Cl. G09G 3/34; G09G 3/00

(52) U.S. Cl. CPC G09G 3/3413; G09G 3/006; G09G 2320/0233; G09G 2320/029; G09G 2320/0673
USPC 345/694

(57) ABSTRACT

A luminance correction system includes a display device including a display unit with a plurality of first pixels, a plurality of second pixels, and a plurality of third pixels, and a data driver configured to supply a data signal to the plurality of first through third pixels, an image pickup unit configured to generate a first image of first pixels which emit light by receiving a data signal corresponding to gray scale value A, and to generate a second image of the first pixels which emit light by receiving a data signal corresponding to gray scale value B, and a luminance measuring unit configured to measure a first luminance of a pixel to be corrected among the first pixels in the first image, and to measure a second luminance of the pixel to be corrected in the second image.

### CROSS-REFERENCE TO RELATED APPLICATION

Korean Patent Application No. 10-2013-0128391 filed on Oct. 28, 2013, in the Korean Intellectual Property Office, and entitled: “LUMINANCE CORRECTION SYSTEM,” is incorporated by reference herein in its entirety.

### BACKGROUND

1. Field

An aspect of embodiments relates to a luminance correction system.

2. Description of the Related Art

Recently, there have been developed various types of display devices capable of reducing the weight and volume of cathode ray tubes. Such display devices include, e.g., a liquid crystal display device (LCD), a field emission display device (FED), a plasma display panel (PDP), an organic light emitting display device (OLED), and the like.

### SUMMARY

According to an aspect of embodiments, there is provided a luminance correction system, including: a display device configured to include a display unit including a plurality of first pixels, a plurality of second pixels and a plurality of third pixels, and a data driver supplying a data signal to the pixels; an image pickup unit configured to generate a first image of first pixels which emit light by receiving a data signal corresponding to gray scale value A, and generate a second image of the first pixels which emit light by receiving a data signal corresponding to gray scale value B; and a luminance measuring unit configured to measure a first luminance of a pixel to be corrected among the first pixels in the first image, and measure a second luminance of the pixel to be corrected in the second image.

The luminance correction system may further include a coordinate calculation unit configured to calculate first and second auxiliary coordinates by multiplying a first gamma function by a first coordinate composed of the gray scale value A and the first luminance and a second coordinate composed of the gray scale value B and the second luminance.

The luminance correction system may further include a function calculation unit configured to calculate a correction function which defines a correspondence relationship between an original gray scale value of the pixel to be corrected and a correction gray scale value, using a target function and an auxiliary function calculated using the first and second auxiliary coordinates.

The target function may be defined by the multiplication of the first gamma function and a second gamma function.

The first gamma function may be a reversed function of the second gamma function.

The correction function may include a first gray scale equation using gray scale values from the gray scale value A to the gray scale value B as variables, a second gray scale equation using gray scale values from gray scale value 0 to the gray scale value A as variables, and a third gray scale equation using gray scale values from the gray scale value B to a final gray scale value as variables.

Each equation may be a primary function.

The first gray scale equation may be represented by the following equation:

Gc=S*Gv+H

(Gc denotes a correction gray scale value, Gv denotes an original gray scale value, and S and H denote constants).

The second gray scale equation may be represented by the following equation:

Gc=(H/A+S)*Gv

(A denotes gray scale value A).

The third gray scale equation may be represented by the following equation:

Gc=[{K−(H+B*S)}*Gv+K*(H+B*S−B)]/(K−B)

(K denotes a final gray scale value, and B denotes gray scale value B).

The display device may further include a gray scale correction unit configured to correct an input gray scale value of the pixel to be corrected, using the correction function, when the gray scale value of the pixel to be corrected is input.

The data driver may convert the correction gray scale value calculated by the gray scale correction unit into a data signal, and supply the converted data signal to the pixel to be corrected.

The image pickup unit may generate a plurality of reference images with respect to each case where first pixels positioned in a predetermined reference area emit light by receiving a data signal corresponding to each gray scale.

The luminance measuring unit may measure an average luminance of each reference area in each reference image.

The function calculation unit may calculate the second gamma function, using a correspondence relationship between the average luminance of each reference area and each gray scale value.

The auxiliary function may be a primary function which passes through the first and second auxiliary coordinates.

### BRIEF DESCRIPTION OF THE DRAWINGS

Features will become apparent to those of ordinary skill in the art by describing in detail exemplary embodiments with reference to the attached drawings, in which:

FIG. 1 is a diagram illustrating a luminance correction system according to an embodiment.

FIG. 2 is a diagram illustrating a display device according to an embodiment.

FIG. 3 is a diagram illustrating a luminance correction device according to an embodiment.

FIG. 4 is a diagram illustrating a first coordinate and a second coordinate according to an embodiment.

FIG. 5 is a diagram illustrating a first gamma function and a second gamma function according to an embodiment.

FIG. 6 is a diagram illustrating a first auxiliary coordinate, a second auxiliary coordinate, an auxiliary function, and a target function according to an embodiment.

FIG. 7 is a diagram illustrating a correction function according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, dimensions may be exaggerated for clarity of illustration. Further, it will be understood that when an element is referred to as being “between” two elements or “coupled” to an element, it can be the only element between the two elements or coupled to the element, or one or more intervening elements may also be present. Like reference numerals refer to like elements throughout. Further, some of the elements that are not essential to the complete understanding of the invention are omitted for clarity.

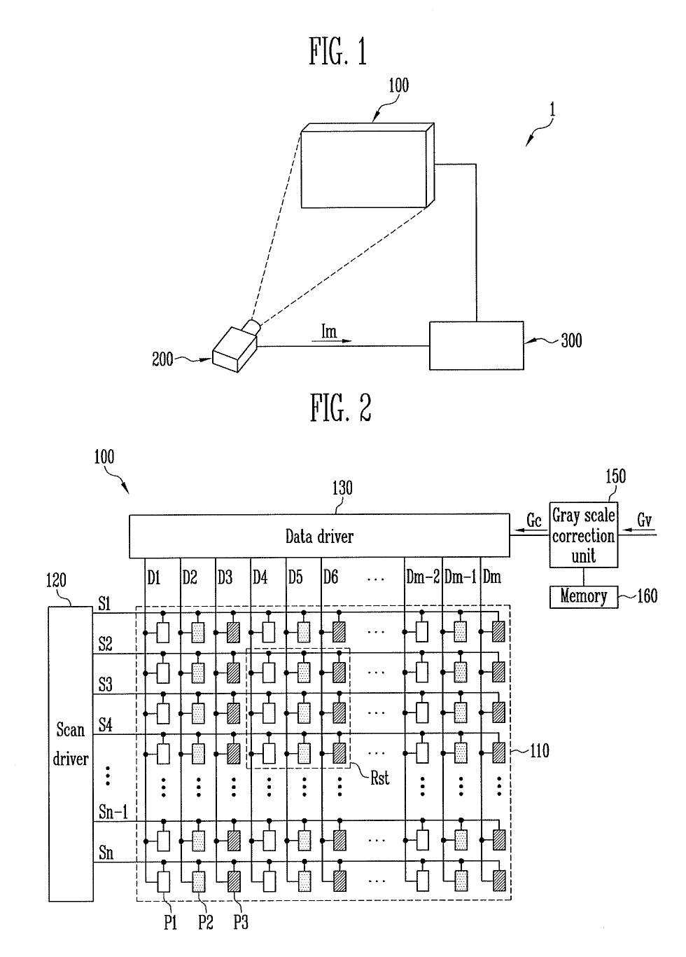

FIG. 1 is a diagram illustrating a luminance correction system according to an embodiment. FIG. 2 is a diagram illustrating a display device according to the embodiment. FIG. 3 is a diagram illustrating a luminance correction device according to the embodiment.

Referring to FIG. 1, a luminance correction system 1 according to this embodiment may include a display device 100, an image pickup unit 200, and a luminance correction device 300.

The display device 100 becomes an object of luminance correction. Before the display device 100 is released, the luminance correction of the display device 100 may be performed through the luminance correction system 1 according to this embodiment.

Referring to FIG. 2, the display device 100 according to this embodiment may include a display unit 110, a scan driver 120, a data driver 130, a gray scale correction unit 150, and a memory 160.

The display unit 110 is an area in which a predetermined image is displayed. The display unit 110 may include a plurality of pixels P1, P2, and P3 coupled to scan lines S1 to Sn and data lines D1 to Dm. For example, the display unit 110 may include a plurality of first pixels P1, a plurality of second pixels P2, and a plurality of third pixels P3. In this case, each of the first, second, and third pixels P1, P2, and P3 may emit light of the same series color. For example, the first pixels P1 may be set as red pixels which emit red light, the second pixels P2 may be set as green pixels which emit green light, and the third pixels P3 may be set as blue pixels which emit blue light.

The scan driver 120 may supply a scan signal to the pixels P1, P2, and P3 through the scan lines S1 to Sn. For example, the scan driver 120 may progressively output a scan signal to the scan lines S1 to Sn.

The data driver 130 may supply a data signal to the pixels P1, P2, and P3 through the data lines D1 to Dm. To this end, the data driver 130 may convert a correction gray scale value Gc calculated by the gray scale correction unit 150 into a data signal corresponding to the correction gray scale value Gc. In this case, the data signal may have a voltage corresponding to the correction gray scale value Gc.

A data signal may be written in pixels P1, P2, and P3 selected by receiving a scan signal, and accordingly, the pixels P1, P2, and P3 can emit light with luminance corresponding to the written data signal. In a case where an original gray scale value Gv is input, the gray scale correction unit 150 may correct the input original gray scale value Gv through a correction function Fc calculated by the luminance correction device 300, as will be described in detail with reference to FIG. 7.

In detail, the gray scale correction unit 150 may calculate the correction gray scale value Gc from the original gray scale value Gv through the correction function Fc, which defines a correspondence relationship between the original gray scale value Gv and the correction gray scale value Gc. The gray scale correction unit 150 may provide the calculated correction gray scale value Gc to the data driver 130.

The memory 160 may store parameters related to the correction function Fc. Thus, the gray scale correction unit 150 can use the correction function Fc with reference to the parameters stored in the memory 160 to calculate the correction gray scale value Gc from the original gray scale value.

The display device 100 according to this embodiment may be a display device such as an organic light emitting display device or a liquid crystal display device. The image pickup unit 200 performs a function of picking up an image displayed in the display device 100. For example, the image pickup unit 200 may pick up an emission of the display unit 110 included in the display device 100, and transmit an image Im generated through the emission of the display unit 110 to the luminance correction device 300, e.g., the image pickup unit 200 may transmit an image signal corresponding to the emitted light of the display unit 110 to the luminance correction device 300.

The luminance correction device 300 calculates the correction function Fc optimized for the display device 100, so that the pixels P1, P2, and P3 included in the corresponding display device 100 can emit light with uniform luminance. The luminance correction device 300 stores parameters related to the calculated correction function Fc in the memory 160, so that the display device 100 can subsequently correct the input original gray scale value Gv, using the correction function Fc.

Referring to FIG. 3, the luminance correction device 300 according to this embodiment may include a luminance measuring unit 310, a coordinate calculation unit 320, a function calculation unit 330, a memory 340, and a control unit 350.

The luminance measuring unit 310 may measure an emission luminance of the pixels P1, P2, and P3, using the image supplied from the image pickup unit 200.

The coordinate calculation unit 320 may calculate first and second auxiliary coordinates Cs1 and Cs2 necessary for calculating an auxiliary function Fs, using the luminance measured by the luminance measuring unit 310 and a first gamma function Fg1.

The function calculation unit 330 may calculate the auxiliary function Fs, using the first and second auxiliary coordinates Cs1 and Cs2 calculated by the coordinate calculation unit 320. The function calculation unit 330 may calculate the correction function Fc which defines a correspondence relationship between the original gray scale value Gv of a pixel to be corrected and the correction gray scale value Gc, using a target function Ft and the auxiliary function Fs. This correction function Fc may be stored in the memory 160 of the display device 100.

Information necessary for operations of the luminance correction device 300 may be stored in the memory 340. For example, the memory 340 may store images Im supplied from the image pickup unit 200, various kinds of functions, intermediate values calculated in a calculation process, and the like.

The control unit 350 may control the luminance measuring unit 310, the coordinate calculation unit 320, the function calculation unit 330, and the memory 340, which are included in the luminance correction device 300. The control unit 350 may perform control operations of the image pickup unit 200 and the display device 100.

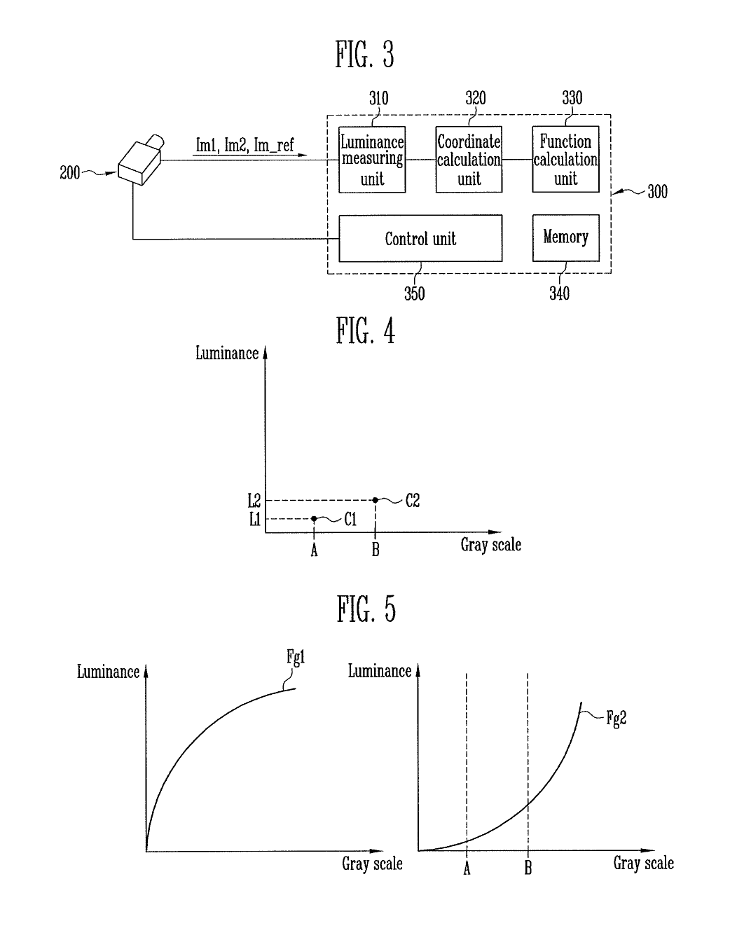

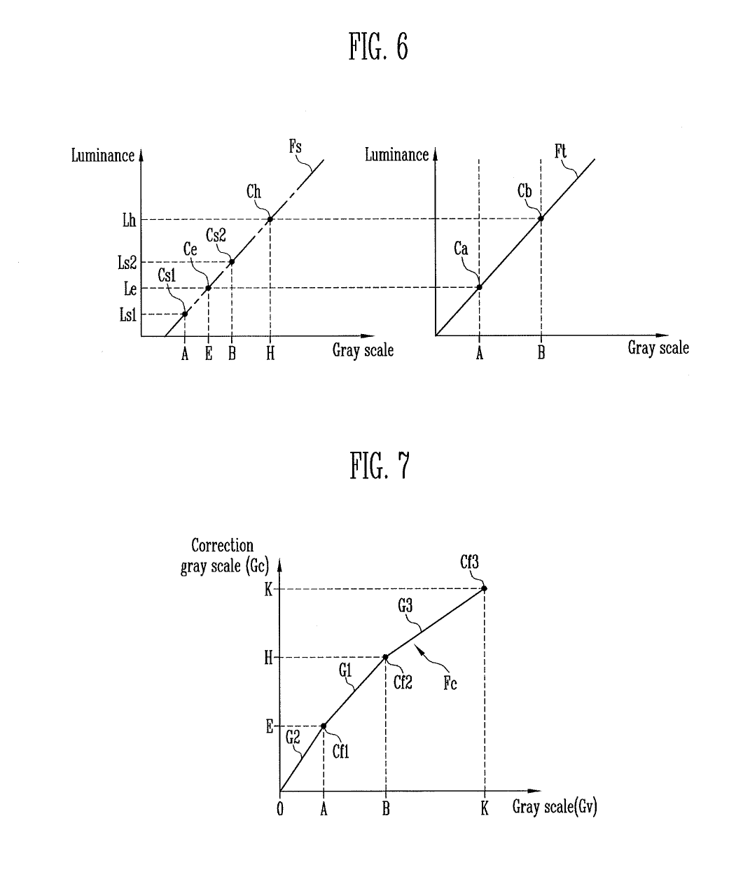

FIG. 4 is a diagram illustrating a first coordinate and a second coordinate according to an embodiment. FIG. 5 is a diagram illustrating a first gamma function and a second gamma function according to an embodiment. FIG. 6 is a diagram illustrating a first auxiliary coordinate, a second auxiliary coordinate, an auxiliary function, and a target function according to the embodiment. FIG. 7 is a diagram illustrating a correction function according to the embodiment.

Hereinafter, the operation of the luminance correction system 1 according to this embodiment will be described in detail with reference to FIGS. 2 and 4-7.

The data driver 130 of the display device 100 may supply a data signal corresponding to a gray scale value A with respect to first pixels P1 among the pixels P1, P2, and P3 included in the display unit 110 during a first period. Accordingly, the first pixels P1 can emit light with luminance corresponding to the gray scale value A during the first period. In this case, the image pickup unit 200 may receive the data signal corresponding to the gray scale value A to pick up the first pixels P1 which emit light, thereby generating a first image Im1 of the first pixels P1.

The data driver 130 may supply a data signal corresponding to a gray scale value B with respect to first pixels P1 among the pixels P1, P2, and P3 included in the display unit 110 during a second period. Accordingly, the first pixels P1 can emit light with luminance corresponding to the gray scale value B during the second period. In this case, the image pickup unit 200 may receive the data signal corresponding to the gray scale value B to pick up the first pixels P1 which emit light, thereby generating a second image Im2 of the first pixels P1.

The image pickup unit 200 may transmit the generated first and second images Im1 and Im2 to the luminance measuring unit 310 included in the luminance correction device 300. The luminance measuring unit 310 may analyze the first and second images Im1 and Im2 transmitted from the image pickup unit 200, thereby measuring the luminance of a pixel to be corrected. In this case, the pixel to be corrected may be any one of the first pixels P1 which emit light by receiving the data signals respectively corresponding to the gray scale values A and B during the first and second periods.

For example, referring to FIG. 4, the luminance measuring unit 310 may measure a first luminance L1 of the pixel to be corrected among the first pixels P1 in the first image Im1, and may measure a second luminance L2 of the pixel to be corrected among the first pixels P1 in the second image Im2. Accordingly, the coordinate calculation unit 320, as shown in FIG. 4, can calculate a first coordinate C1 composed of the gray scale value A and the first luminance L1 and a second coordinate C2 composed of the gray scale value B and the second luminance L2. For example, the first coordinate C1 may be expressed in a coordinate form such as (A, L1), and the second coordinate C2 may be expressed in a coordinate form such as (B, L2).

The coordinate calculation unit 320 may calculate the first and second auxiliary coordinates Cs1 and Cs2 shown in FIG. 6 by multiplying each of the first and second coordinates C1 and C2 by a first gamma function Fg1 (see FIG. 5). In this case, the first auxiliary coordinate Cs1 may be composed of the gray scale value A and a luminance value Ls1, and the second auxiliary coordinate Cs2 may be composed of the gray scale value B and a luminance value Ls2. Therefore, the first auxiliary coordinate Cs1 may be expressed in a coordinate form such as (A, Ls1), and the second auxiliary coordinate Cs2 may expressed in a coordinate form such as (B, Ls2).

Referring to FIGS. 6 and 7, the function calculation unit 330 may calculate the correction function Fc, which defines the correspondence relationship between the original gray scale value Gv of a pixel to be corrected and the correction gray scale value Gc, using the target function Ft and the first and second auxiliary coordinates Cs1 and Cs2. In this case, the correction function Fc, as shown in FIG. 7, includes a first gray scale equation G1 using gray scale values from the gray scale value A to the gray scale value B as variables, a second gray scale equation G2 using gray scale values from the gray scale value of zero (0) to the gray scale value A as variables, and a third gray scale equation G3 using gray scale values from the gray scale value B to a final gray scale value as variables.

The function calculation unit 330 may calculate the auxiliary function Fs, using the first and second auxiliary coordinates Cs1 and Cs2. In this case, the auxiliary function Fs may be a primary function which passes through the first and second auxiliary coordinates Cs1 and Cs2.

The target function Ft may be stored in the memory 340, and the function calculation unit 330 may call the target function Ft stored in the memory 340 to calculate the correction function Fc. For example, the target function Ft may be a primary function, as shown in FIG. 6.

The target function Ft may be calculated by the multiplication of first and second gamma functions Fg1 and Fg2. In this case, the second gamma function Fg2 may be calculated by measuring an emission luminance corresponding to each gray scale value of the first pixels P1 positioned in a predetermined reference area Rst.

To this end, the data driver 130 may supply a data signal corresponding to each gray scale value of the first pixels P1 positioned in the reference area Rst. For example, the data driver 130 may progressively supply to the first pixels P1 positioned in the reference area Rst, data signals from a data signal corresponding to the gray scale 0, i.e., an initial gray scale value, to a data signal corresponding to a gray scale value K, i.e., a final gray scale. Thus, the first pixels P1 positioned in the reference area Rst can emit light with luminance corresponding to each gray scale value.

The reference area Rst may be set as at least a partial area of the display unit 110. The reference area Rst may include a plurality of first pixels P1. In this case, the image pickup unit 200 may receive a data signal corresponding to each gray scale value of the first pixels P1 positioned in the reference area Rst and pick up each emission case, thereby generating a reference image Im_ref of each emission case.

The image pickup unit 200 may transmit the generated reference images Im_ref to the luminance measuring unit 310 included in the luminance correction device 300. The luminance measuring unit 310 may analyze each reference image Im_ref, thereby calculating the average luminance of each reference area Rst included in each reference image Im_ref. For example, the average luminance of each reference area Rst may be an average luminance of the first pixels P1 positioned in the reference area Rst.

The function calculation unit 330 may derive a second gamma function Fg2 shown in FIG. 5, using a correspondence relationship between each gray scale value and an average luminance of each reference area Rst. In this case, the first gamma function Fg1 may be a reverse function of the second gamma function Fg2. Therefore, the target function Ft calculated by the multiplication of the first and second gamma functions Fg1 and Fg2 may be a primary function.

Both the auxiliary function Fs and the target function Ft are primary functions, and accordingly, the function calculation unit 330 can easily calculate the correction function Fc. That is, both the y-axes of the auxiliary function Fs and the target function Ft represent luminance, and thus the x-axis of the auxiliary function Fs and the y-axis of the target function Ft can correspond to each other, based on the luminance.

For example, it is assumed that the a coordinate Ca of the target function Ft is composed of the gray scale value A and luminance value Le, the b coordinate Cb of the target function Ft is composed of the target value B and luminance value Lh, the e coordinate Ce of the auxiliary function Fs is composed of the gray scale value E and luminance value Le, and the h coordinate Ch of the auxiliary function Fs is composed of the gray scale H and luminance value Lh.

In this case, the gray scale A of the target function Ft and the gray scale E of the auxiliary function Fs may correspond to each other, based on the luminance value Le, and the gray scale B of the target function Ft and the gray scale H of auxiliary function Fs may correspond to each other, based on the luminance value Lh. Thus, a first final coordinate Cf1 composed of the gray scale values A and E and a second final coordinate Cf2 composed of the gray scale values B and H can be calculated as shown in FIG. 7.

Through the aforementioned process, the first gray scale equation G1 in the correction function Fc can be calculated. That is, the gray scale value of the auxiliary function Fs, corresponding to the gray scale value A to B of the target function Ft is derived based on the luminance value, thereby calculating the first gray scale equation G1 that is a primary function passing through the first and second final coordinates Cf1 and Cf2. Thus, the first gray scale equation G1 can be represented by the following equation.

Gc=S*Gv+H Equation G1

In Equation G1 above, Gc denotes the correction gray scale value, Gv denotes the original gray scale value, and S and H denote constants.

In the correction function Fc, the correction gray scale value Gv is necessarily set as the minimum gray scale value 0 when the original gray scale value Gv is the minimum gray scale value 0. Therefore, the second gray scale equation G2 may be a primary function passing through the origin and the first final coordinate Cf1. Thus, the second gray scale equation G2 can be represented by the following equation.

Gc=(H/A+S)*Gv Equation G2

In Equation G2 above, A denotes gray scale value A.

In the correction function Fc, the correction gray scale value Gv is necessarily set as the final gray scale value K when the original gray scale value Gv is the final gray scale value K. Therefore, the third gray scale equation G3 may be a primary function passing through the second final coordinate Cf2 and a third final coordinate Cf3. In this case, the third final coordinate Cf3 may be expressed in a coordinate form such as (K, K). Thus, the third gray scale equation G3 can be represented by the following equation.

Gc=[{K−(H+B*S)}*Gv+K*(H+B*S−B)]/(K−B) Equation G3

In Equation G3 above, K denotes a final gray scale value, and B denotes gray scale value B.

The control unit 350 may output parameters (e.g., slopes, y intercepts and the like of the gray scale equations G1, G2 and G3) related to the calculated correction function Fc in the memory 160 of the display device 100. Therefore, the gray scale correction unit 150 of the display device 100 may use the correction function Fc based on parameters stored in the memory 160 by the control unit 350 of the luminance correction device 300, e.g., parameters of the gray scale equations G1, G2 and G3, to calculate the correction gray scale value Ge from the original gray scale value.

For example, in a case where the original gray scale value Gv is input to a pixel to be corrected, the gray scale correction unit 150 may convert the original gray scale value Gv into a correction gray scale value Ge, using the correction function Fc. The gray scale correction unit 150 may transmit the converted correction gray scale value Gc to the data driver 130. Accordingly, the data driver 130 can convert the correction gray scale value Gc calculated by the gray scale correction unit 150 into a data signal corresponding to the correction gray scale value Gc, and supply the converted data signal to the pixel to be corrected. Thus, the emission luminance of the pixel to be corrected can be corrected.

By changing the pixel to be corrected and repeating the aforementioned process, the emission luminance of all the pixels P1, P2 and P3 included in the display unit 110 can be corrected. Accordingly, the display device 100 can have uniform luminance.

By way of summation and review, a luminance variation may occur between pixels included in each display device due to a characteristic variation between the pixels, a variation between manufacturing processes, and the like. As a result, a luminance spot may occur due to the luminance variation, and the image quality of the display device may be deteriorated.

Therefore, in the luminance correction system according to embodiments, the luminance variation between the pixels is removed, thereby providing a display device with uniform image quality, from which a luminance spot is removed. Further, the luminance correction is performed using a primary function, so that it is possible to remarkably reduce correction time.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A luminance correction system, comprising:
a display device including a display unit with a plurality of first pixels, a plurality of second pixels, and a plurality of third pixels, and a data driver configured to supply a data signal to the plurality of first through third pixels;
an image pickup unit configured to generate a first image of first pixels which emit light by receiving a data signal corresponding to gray scale value A, and to generate a second image of the first pixels which emit light by receiving a data signal corresponding to gray scale value B; and
a luminance measuring unit configured to measure a first luminance of a pixel to be corrected among the first pixels in the first image, and to measure a second luminance of the pixel to be corrected in the second image.

2. The luminance correction system as claimed in claim 1, further comprising a coordinate calculation unit configured to calculate first and second auxiliary coordinates, the first auxiliary coordinate being a product of a first gamma function and a first coordinate composed of the gray scale value A and the first luminance, and the second auxiliary coordinate being a product of the first gamma function and a second coordinate composed of the gray scale value B and the second luminance.

3. The luminance correction system as claimed in claim 2, further comprising a function calculation unit configured to calculate a correction function using a target function and an auxiliary function, the correction function defining a correspondence relationship between an original gray scale value of the pixel to be corrected and a correction gray scale value, and the auxiliary function being defined by the first and second auxiliary coordinates.

4. The luminance correction system as claimed in claim 3, wherein the target function is defined by a product of the first gamma function and a second gamma function.

5. The luminance correction system as claimed in claim 4, wherein the first gamma function is a reverse function of the second gamma function.

6. The luminance correction system as claimed in claim 3, wherein the correction function includes a first gray scale equation using gray scale values from the gray scale value A to the gray scale value B as variables, a second gray scale equation using gray scale values from gray scale value 0 to the gray scale value A as variables, and a third gray scale equation using gray scale values from the gray scale value B to a final gray scale value as variables.

7. The luminance correction system as claimed in claim 6, wherein each gray scale equation is a primary function.

8. The luminance correction system as claimed in claim 6, wherein the first gray scale equation is represented by the following equation:
Gc=S*Gv+H,
wherein Gc denotes a correction gray scale value, Gv denotes an original gray scale value, and S and H denote constants.

9. The luminance correction system as claimed in claim 8, wherein the second gray scale equation is represented by the following equation:
Gc=(H/A+S)*Gv,
wherein A denotes gray scale value A.

10. The luminance correction system as claimed in claim 9, wherein the third gray scale equation is represented by the following equation:
Gc=[{K−(H+B*5)}*Gv+K*(H+B*S−B)]/(K−B),
wherein K denotes a final gray scale value, and B denotes gray scale value B.

11. The luminance correction system as claimed in claim 3, wherein the display device further comprises a gray scale correction unit configured to correct an input gray scale value of the pixel to be corrected, using the correction function, when the gray scale value of the pixel to be corrected is input.

12. The luminance correction system as claimed in claim 11, wherein the data driver converts the correction gray scale value calculated by the gray scale correction unit into a data signal, and supplies the converted data signal to the pixel to be corrected.

13. The luminance correction system as claimed in claim 3, wherein the image pickup unit generates a plurality of reference images with respect to each case where first pixels positioned in a predetermined reference area emit light by receiving a data signal corresponding to each gray scale.

14. The luminance correction system as claimed in claim 13, wherein the luminance measuring unit measures an average luminance of each reference area in each reference image.

15. The luminance correction system as claimed in claim 14, wherein the function calculation unit calculates the second gamma function, using a correspondence relationship between the average luminance of each reference area and each gray scale value.

16. The luminance correction system as claimed in claim 3, wherein the auxiliary function is a primary function which passes through the first and second auxiliary coordinates.
